(19) United States
(12) Patent Application Publication
(10) Pub. No.: US 2012/0031844 A1
(43) Pub. Date: Feb. 9, 2012

(54) FLOW-SWITCH-CONTROLLED, ZERO WASTE REVERSE OSMOSIS WATER TREATMENT SYSTEM

(75) Inventor: MARK J. ST. HILAIRE, Hamilton, MA (US)

(73) Assignee: ATLAS WATER SYSTEMS, INC., Waltham, MA (US)

(21) Appl. No.: 13/196,006

(22) Filed: Aug. 2, 2011

Related U.S. Application Data
(60) Provisional application No. 61/370,146, filed on Aug. 3, 2010.

(51) Int. Cl. C02F 1/44; B01D 61/08; B01D 61/12

(52) U.S. Cl. 210/652; 210/137; 210/196

(57) ABSTRACT

A flow-switch controlled, zero waste reverse osmosis water treatment system having a first conduit for providing a supply of water, a second conduit having an inlet in fluid communication with the first conduit for selectively receiving a flow of water from the first conduit, a reverse osmosis element positioned along the second conduit, the reverse osmosis element separating the flow of water within the second conduit into a purified water stream and a reject water stream, a purified water conduit having an inlet configured to receive the purified water stream and a reject water conduit having an inlet configured to receive the reject water stream and an outlet in fluid communication with the first conduit.

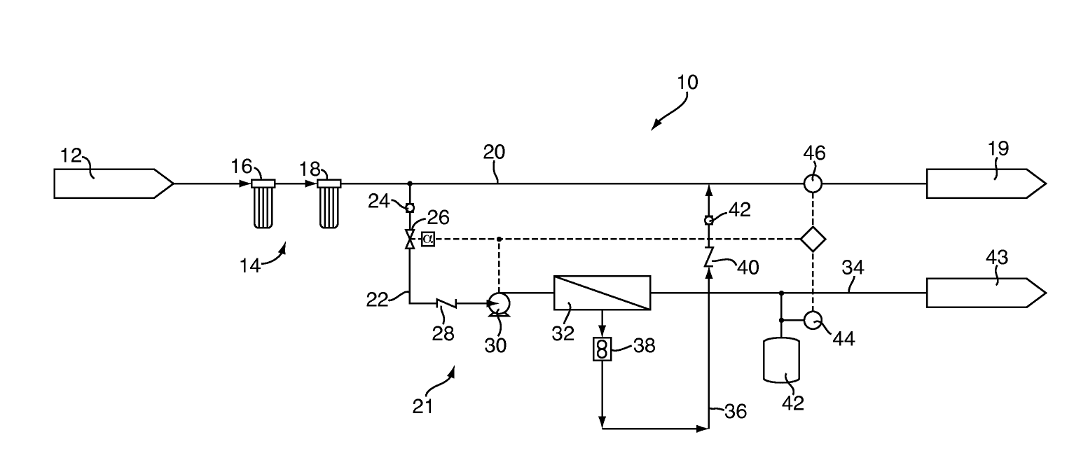

### CROSS REFERENCE TO RELATED APPLICATIONS

This application claims the benefit of U.S. Provisional Application Ser. No. 61/370,146, filed on Aug. 3, 2010, which is herein incorporated by reference in its entirety.

### FIELD OF THE INVENTION

The present invention relates generally to water treatment systems and, more particularly, to a flow switch controlled, zero waste reverse osmosis water treatment system.

### BACKGROUND OF THE INVENTION

Reverse osmosis is a water filtration method that removes many types of large molecules and ions from a solution. Typically, reverse osmosis water filtration utilizes a semi-permeable membrane that has the ability to remove and reject a wide spectrum of impurities and contaminants from such solution. In such a method, a predetermined pressure is applied to the incoming water through the membrane. The membrane filters impurities and large molecules from the incoming water, leaving purified water on one side of the membrane and what is referred to as reject water on the other side. The impurities that cannot pass through the membrane may then be carried away in the reject water stream.

Around the world, household drinking water purification systems often employ a similar reverse osmosis process for improving water for drinking and cooking. Conventional systems for purifying water by the process of reverse osmosis (RO) produce, in addition to desired purified water, a considerable amount of reject water, also known as waste water or concentrate water. In known reverse-osmosis water purifying systems, this reject water, which is a by-product of the RO process, is customarily flushed down the drain of the residence, business or other building in which the reverse osmosis system is installed.

Notably, most known zero waste reverse osmosis water treatment systems are level driven, i.e., they are switched on when the purified water in an accumulator tank drops below a certain pressure level. In such systems, the concentrate or total dissolved solids (TDS) which would normally be flushed down the drain are input back into the closed water supply system until the water level in the accumulator tank reaches a predetermined high pressure level. This is undesirable because there is the potential for high pressure problems if the concentrate is presented to the water system when the system is closed and there is no water movement. Moreover, known zero waste systems return the reject or waste water to the hot water line, which can contribute to the build up of TDS in the hot water line, especially at the point where the connection is made. With such systems, there is also the potential for increased water pressure that is generated by the RO pressure booster pump.

In view of the problems associated with known reverse osmosis water treatment systems, there is a need for a zero waste reverse osmosis water treatment system that is demand driven and wherein the concentrate or reject water stream is diluted almost instantly such as to avoid any significant pressure or increasing TDS problems within the system.

### SUMMARY OF THE INVENTION

In view of the foregoing, it is an object of the present invention to provide a water treatment system.

It is another object of the present invention to provide a flow switch controlled water treatment system.

It is another object of the present invention to provide a flow switch controlled reverse osmosis water treatment system.

It is another object of the present invention to provide a flow switch controlled reverse osmosis water treatment system having zero waste.

It is yet another object of the present invention to provide a zero waste reverse osmosis water treatment system that avoids potential high pressure buildup in the system associated with known systems.

It is another object of the present invention to provide a zero waste reverse osmosis water treatment system that instantly dilutes reject water.

It is another object of the present invention to provide a zero waste reverse osmosis water treatment system that only generates purified water when water is flowing through a building's water distribution system, i.e., when water is on demand.

It is another object of the present invention to provide a method of controlling reverse osmosis water production with a flow switch and a pressure switch combination.

It is another object of the present invention to provide a method of controlling any commercially available reverse osmosis system using the method of controlling reverse osmosis water production of the present invention.

### BRIEF DESCRIPTION OF THE DRAWINGS

The present invention will be better understood from reading the following description of non-limiting embodiments, with reference to the attached drawing, wherein below:

The sole FIGURE is a schematic flow diagram of a zero waste reverse osmosis water treatment system in accordance with one embodiment of the present invention.

### DETAILED DESCRIPTION OF THE PREFERRED EMBODIMENTS

The zero waste reverse osmosis water treatment system of the present invention, shown generally at 10, includes a water source, such as a water main 12 or conduit coming from the street or well. In the preferred embodiment, the system 10 includes a pre-filter array 14 positioned upstream from the water source for the filtration of various impurities. For example, the pre-filter array may include a whole home sediment filter 16 for sediment filtration and/or a whole home carbon filter 18 for carbon filtration, such as those known in the art. The sediment filter 16 and carbon filter 18 function to remove any sediment and/or carbon in the water passing through the water main 12.

Once the water passes through this optional pre-filter array 14, it may be piped directly into a home or building to one or more utility/mains water outlets 19 through a main supply line/conduit 20 for use where purified water is not required, such as for showers, washing dishes and laundry. Alternatively, the water may be diverted from the main supply line 20 to a reverse osmosis parallel flowpath 21 by way of a RO line/conduit 22 for further purification. As shown, the reverse osmosis parallel flowpath 21 and, in particular the RO line 22, contains the main components of the zero waste reverse osmosis water treatment system 10, as discussed in detail below. In particular, the RO line 22 includes a ball valve 24 for selectively controlling a flow of water from the main supply line 20 through the RO line 22, an inlet solenoid valve 26, a check valve 28 and a booster pump 30. An outlet of the booster pump 30 is in fluid communication with an inlet of a reverse osmosis element 32. In the preferred embodiment, the reverse osmosis element 32 is a semi-permeable membrane that has the ability to remove and reject a wide spectrum of impurities and contaminants, such as those known in the art. The reverse osmosis element 32 includes two outlets, a first outlet fluidly coupled to a purified water line 34 and a second outlet fluidly coupled to a reject water line 36.

The reject water line 36 includes a reverse osmosis reject flow control unit 38 a check valve 40 and a ball valve 42. As will be readily appreciated, the check valve 40 prevents water flowing through main supply line 20, to a house or building, from flowing backwards through the reject water line 36 when the reverse osmosis system is not in use. The reject water line 36 terminates at, and is in fluid communication with, the main supply line 20 such that reject water may be mixed with mains water to instantly dilute the reject water and the filtered impurities therein, as discussed below.

As also shown, the purified water line 34 is in fluid communication with a reverse osmosis accumulator tank 42. As discussed below, the reverse osmosis accumulator tank 42 stores purified water that has passed through the reverse osmosis element 32, where it can then be piped to a purified water outlet 43 (such as a faucet) for use on demand (such as for drinking water). The reverse osmosis accumulator tank 42 is configured with a pressure switch 44, which provides the advantages discussed hereinafter.

Importantly, a flow switch 46 is positioned in the main supply line 20 and is electrically coupled to the inlet solenoid valve 26, booster pump 30 and pressure switch 44 for controlling operation thereof and for controlling a flow of water through the system 10. The flow switch 46 may be installed in the water main of a building, or in a sub water main in the case of a larger building. As discussed in detail below, the system 10 also preferably includes a sensor, not shown, which identifies when water is flowing in the main supply line 20, caused by normal demand, for uses such as showers and laundry, i.e., main water flow as opposed to reverse osmosis/purified water flow.

As shown, the system 10 includes a parallel flow path 21 or side-stream flow, as noted above, where water is diverted from the main supply line 20 in the house or building for further filtration. Once filtration is achieved, the purified water is piped to the accumulator tank 42 and then to dedicated faucets 43 or other points of use in the house or building through a dedicated purified pipe system. The reject water stream that did not pass through the reverse osmosis element 32 as purified water is then piped back into the main supply 20 before or after the point of entry into the sediment and carbon filters 16, 18, as hereinafter discussed.

Operation of the reverse osmosis water treatment system 10 will now be described with further reference to the drawing. In operation, utility water begins downstream of the flow switch 46 through the main supply line 20. Upon detecting the flow of water through the main supply line 20, the flow switch 46 energizes and sends power to the inlet solenoid valve 26 and reverse osmosis booster pump 30. The inlet solenoid 26 is controlled to its open position such that water is diverted from the main supply line 20 to the RO line 22. The booster pump 30 is actuated to increase the water pressure and flow through the RO line 22 and into the reverse osmosis element 32. Essentially, the booster pump 30 serves to force water through the semi-permeable membrane of the reverse osmosis element 32.

The reverse osmosis element 32 functions to remove impurities and contaminants from the water passing through the RO line 22 and divides the incoming water into two outlet streams, a reverse osmosis/purified water stream which is the diverted into the purified water line 34, and a reject water stream (containing impurities and contaminants) which is diverted into the reject water line 36.

The pressurized reject water stream flows through the reject water line 36 and through the reject flow control unit 38 and check valve 40, and is returned to the flow of utility/mains water through the main supply line 20. Importantly, this reject water stream is immediately diluted in the flow of utility water and the increased water pressure is immediately reduced to match the line pressure of the main supply line 20. Conversely, the purified water steam in the purified water line 34 is routed to the reverse osmosis accumulator tank 42 for use on demand.

Importantly, once water flow through the main supply line 20 ceases, the flow switch 46 automatically de-energizes and power to the inlet solenoid valve 26 and the reverse osmosis booster pump 30 is interrupted, thus stopping the flow of water through the RO line 22 and stopping the reverse osmosis water purification process.

Preferably, the pressure switch 44 associated with the reverse osmosis accumulator tank 42 continuously or intermittingly monitors a level of purified water in the tank 42. If the pressure switch 44 indicates that the reverse osmosis accumulator tank 42 is full, power to the inlet solenoid valve 26 will be interrupted such that the inlet solenoid valve 26 is controlled to its closed position, and the booster pump 30 will be shut off.

In the preferred embodiment, power to the inlet solenoid valve 26 and booster pump 30 may only be restored when the pressure switch 44 indicates that the purified water level in reverse osmosis accumulator tank 42 has fallen below a predetermined level and there is again water flow downstream of the flow switch 46, such as when a utility outlet 19 is opened to initiate the flow of utility/mains water through main supply line 20.

Importantly, reverse osmosis purified water production only takes place when the utility/mains water is being used in the home or building. That is, water is only diverted from the main supply line 20 to the RO line 22 for purification when other than purified water, i.e., utility/mains water, is being utilized. During purified water production, the reject water stream that did not pass through the membrane as purified water is returned to the water main or sub water main through the reject water line 36 while utility water is being used. The mechanisms of producing the reverse osmosis product and reject water streams only during water use, and returning the reject water stream to the water main only during water use, significantly reduces or eliminates any potential of the total dissolved solids significantly increasing at the reject line connection point back to the main supply line. In addition, the reverse osmosis water treatment method of the present invention also significantly reduces or eliminates any potential increase in water pressure, as purified and reject water streams are only being produced when there is an open discharge point somewhere downstream in the plumbing system, i.e., when someone in the house or building is utilizing mains/utility water, i.e., other than purified water.

As noted above, one of the advantages of the present invention is that purified water is generated only during water flow through the house or building; consequently, the reject water stream is diluted instantly by mixing it with the flow of water through the main supply line 20. Accordingly, the present invention ensures that there is no issue with potential high pressure problems within the system. As will be readily appreciated from the above, the primary focus of the system is to only generate purified RO water when the water is flowing through the main supply line 20 and into a house/building.

As noted above, a sensor positioned in the main supply line 20 senses the fluid flow in the main supply line 20 and uses the signal generated by such sensor to initiate the diversion of the water from the main supply line 20 to the RO line 22 to initiate RO water production. Preferably, there may still be a water level sensor in the accumulator tank 42, however, unlike prior art systems which generate RO water when the water level in the accumulator tank drops below a certain level, the system of the present invention only generates RO/purified water when the sensor senses water movement upstream from the accumulator tank 42, such as in the main supply line 20. Consequently, there cannot be a situation where the RO booster pump 30 is activated when there is no water flowing through the main supply line 20 and into a structure.

While there is the possibility that if only the RO/purified water stored in the accumulator tank 42 is used, i.e., mains/utility water is not used, the system can go dry, in the majority of instances there will be enough utility water use in a home or building throughout the day to support demand for RO/purified water production in a home or building while that utility water is being used.

In yet another embodiment, the present invention provides a method of controlling reverse osmosis water production with a flow switch and pressure switch, combined with the method of returning reverse osmosis reject water to be fully diluted by the use of utility water in the home or building to the water main in the house or building. In this embodiment, there may be a time delay included such that the pump runs for a pre-selected period of time after the water shuts off.

In yet another embodiment, the flow switch controlled, zero waste reverse osmosis water treatment system 10 disclosed above may be combined with any type of whole home or partial building filtration system known in the art to provide the added benefits inherent with the present invention, as described above, in addition to the known benefits of the various types of whole or partial home or business filtration systems. In connection with this, the flow switch controlled, zero waste reverse osmosis water treatment system 10 of the present invention may be retrofit with existing systems to provide the added advantages noted above.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A flow-switch controlled, zero waste reverse osmosis water treatment system, comprising:
a first conduit for providing a supply of water;
a second conduit having an inlet in fluid communication with said first conduit for selectively receiving a flow of water from said first conduit;
a reverse osmosis element positioned along said second conduit, said reverse osmosis element separating said flow of water within said second conduit into a purified water stream and a reject water stream;
a purified water conduit having an inlet configured to receive said purified water stream; and
a reject water conduit having an inlet configured to receive said reject water stream and an outlet in fluid communication with said first conduit for directing said reject water stream into said first conduit.

2. The reverse osmosis water treatment system of claim 1, further comprising:
a solenoid valve positioned in said second conduit for selectively controlling said flow of water into said second conduit.

3. The reverse osmosis water treatment system of claim 2, further comprising:
a booster pump in fluid communication with said second conduit and configured to increase a pressure and flow of water to said reverse osmosis element.

4. The reverse osmosis water treatment system of claim 1, further comprising:
a pre-filter array including at least one of a sediment filter and a carbon filter in fluid communication with said first conduit and positioned upstream from said second conduit.

5. The reverse osmosis water treatment system of claim 3, further comprising:
a flow switch positioned along said first conduit and electrically coupled to said inlet solenoid valve and said booster pump and configured to control operation of said solenoid valve and said booster pump to control a flow of water through said system.

6. The reverse osmosis water treatment system of claim 1, wherein:
said reverse osmosis element includes a semi-permeable membrane.

7. The reverse osmosis water treatment system of claim 5, further comprising:
an accumulator tank in fluid communication with said purified water conduit and configured to store purified water received form said purified water conduit.

8. The reverse osmosis water treatment system of claim 7, wherein:
said accumulator tank includes a pressure switch electrically coupled to said flow switch, said pressure switch being configured to monitor a level of purified water in said accumulator tank.

9. The reverse osmosis water treatment system of claim 1, further comprising:
a flow control unit configured in said reject water conduit and operable to control a flow of said reject water stream therethrough.

10. The reverse osmosis water treatment system of claim 4, wherein:
said outlet of said reject water conduit is fluidly coupled to said first conduit upstream from said pre-filter array.

11. The reverse osmosis water treatment system of claim 4, wherein:
said outlet of said reject water conduit is fluidly coupled to said first conduit downstream from said pre-filter array.

12. The reverse osmosis water treatment system of claim 8, further comprising:
a utility water outlet fluidly coupled to said first conduit; and
a purified water outlet fluidly coupled to said accumulator tank.

13. A reverse osmosis water treatment method, said method comprising the steps of:
passing a flow of utility water containing impurities through a reverse osmosis element to produce a purified water stream and a reject water stream; and
reintroducing said reject water stream to said flow of utility water to dilute said reject water stream.

14. The method according to claim 13, further comprising the step of:
diverting said flow of water from a main supply line to a filtration line containing said reverse osmosis element; and
wherein said reject water stream is reintroduced into said flow of utility water in said main supply line.

15. The method according to claim 14, wherein:
said step of diverting said flow of water to said filtration line includes the steps of detecting when said flow of water is present in said main supply line and controlling an inlet valve to an open position when said flow of water in said main supply line is detected to permit said flow of water into said filtration line.

16. The method according to claim 15, wherein:
actuating a booster pump to increase a pressure and flow of water within said filtration line.

17. The method according to claim 16, further comprising the steps of:
monitoring a level of purified water in an accumulator tank; and
controlling said inlet valve to a closed position and interrupting a supply of power to said booster pump whenever said level exceeds a predetermined value.

18. The method according to claim 13, further comprising the step of:
passing said flow of water through at least one of a sediment filter and a carbon filter prior to said step of passing said flow of water through said reverse osmosis element.

19. The method according to claim 18, wherein:
said reject water stream is reintroduced to said flow of water upstream from said at least one of said sediment filter and said carbon filter.

20. A water purification system, comprising:
a supply passageway configured to accommodate a flow of utility water having a plurality of impurities therethrough;
a filter element positioned within said passageway and configured to separate said flow of utility water into a purified water stream being substantially free from said impurities, and a waste water stream containing said impurities; and
a waste water passageway having an inlet and an outlet, said inlet being in fluid communication with said filter element and configured to accept said waste water stream, and said outlet being in fluid communication with said supply passageway and configured to direct said waste water stream to said supply passageway to dilute said waste water stream in said flow of utility water.
